(19) United States
(12) Patent Application Publication
(10) Pub. No.: US 2025/0307891 A1
(43) Pub. Date: Oct. 2, 2025

(54) PLATFORM FOR COUTURE AND READY-TO-WEAR FASHION PURCHASES AND SALES

(71) Applicants: Ugochukwu Ekpemu, Cypress, TX (US); Uzoamaka Ekpemu, Cypress, TX (US); Ijeoma Nwokeohuru, Perth Amboy, NJ (US); Gbemisola Adewuya, Houston, TX (US)

(72) Inventors: Ugochukwu Ekpemu, Cypress, TX (US); Uzoamaka Ekpemu, Cypress, TX (US); Ijeoma Nwokeohuru, Perth Amboy, NJ (US); Gbemisola Adewuya, Houston, TX (US)

(21) Appl. No.: 19/092,231

(22) Filed: Mar. 27, 2025

Related U.S. Application Data
(60) Provisional application No. 63/570,528, filed on Mar. 27, 2024.

(51) Int. Cl. G06Q 30/0601

(52) U.S. Cl. CPC G06Q 30/0621; G06Q 30/0643

(57) ABSTRACT

A platform for connecting couture and ready-to-wear fashion inclined clients with fashion designers through fashion designer vendors wherein the fashion designer vendors provide the fashion products for the client, the fashion products including quality custom-made clothing. The platform includes a space for fashion designer vendors to display fabrics on sale, a message board for the fashion designer vendors and a message board for the client. The fashion designer vendors create a profile on the platform, including a shipping profile. The client selects at least one designer as a preferred designer to allow the platform to provide a preferred fashion selection from the platform. The platform includes steps to coordinate selection, purchase and delivery of products from the fashion designer vendors to the client.

### CROSS-REFERENCE TO RELATED APPLICATIONS

This application is a Utility Patent application claiming priority to U.S. Provisional Patent Application Ser. No. 63/570,528, filed on Mar. 27, 2024, which is incorporated by reference herein in its entirety.

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of fashion sales, and more specifically to fashion sales catering to couture and ready-to-wear fashion.

### 2) Description of Related Art

There is currently a lack of couture and ready-to-wear fashion available on platforms which provide fashion pairing for clients and fashion designers. There are no systems currently available which makes it easy for a client to view and purchase couture and ready-to-wear fashion products what suit the client tastes and purchase abilities. What is needed is a platform which includes many aspects of a purchase including finding, choosing and purchasing the couture and ready-to-wear fashion products. The platform should have the ability to correctly size the products for the client as well as include all aspects of the purchase including creating a profile for both the fashion design vendors and the client. The platform should include security protocols and the ability to make appointments.

### BRIEF SUMMARY OF THE INVENTION

The instant invention in one form is directed to a platform for connecting fashion inclined clients with fashion designers through fashion designer vendors wherein the fashion designer vendors provide the fashion products for the client, the fashion products including quality custom-made clothing. The platform includes a space for fashion designer vendors to display fabrics on sale, a message board for the fashion designer vendors and a message board for the client. The fashion designer vendors create a profile on the platform, including a shipping profile. The client selects at least one designer as a preferred designer to allow the platform to provide a preferred fashion selection from the platform. The platform includes steps to coordinate selection, purchase and delivery of products from the fashion designer vendors to the client.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A shows a first flowchart of the platform according to the present invention;

FIG. 1B shows a second flowchart of the platform according to the present invention; and

FIG. 2 shows a flowchart of an example of a customer in a specific location sourcing customized clothing.

The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

### Mobile App/Website

The platform offers a versatile cross-platform experience through its mobile app and website. Designed with user convenience in mind, both platforms provide seamless access to a wide range of features aimed at connecting customers with designers/vendors worldwide.

### Features

User-Friendly Interface: The mobile app and website feature intuitive interfaces, making navigation effortless for users of all levels of tech-savviness.

Profile Creation: Users can easily create personalized profiles, providing essential information such as contact details, style preferences, and measurement specifications.

Customization Tools: The platform offers robust customization tools, allowing customers to articulate their clothing requirements through detailed descriptions, design images, and measurement inputs.

Designer/Vendor Selection: Customers have the freedom to browse through a diverse selection of designers/vendors, exploring their portfolios and specialties before making an informed decision.

Communication Channels: Direct communication channels, including messaging and video boards, facilitate seamless collaboration between customers and designers/vendors throughout the design process.

Secure Payment Gateway: A secure payment gateway ensures safe and hassle-free transactions, offering multiple payment options to suit individual preferences.

Order Tracking: Customers can track the progress of their orders in real-time, receiving notifications at each stage of the production and delivery process.

Feedback and Rating System: Upon receiving their custom-made clothing, customers can provide feedback and ratings based on their experience, contributing to a transparent and trustworthy community ecosystem.

Virtual Fitting Room: AI technology captures body measurements and enable clients try on clothing virtually.

### How It Works

1. Account Creation: Users begin by creating a personalized account on the mobile app or website, providing essential information and preferences.
2. Clothing Requirements: Users articulate their clothing requirements through detailed descriptions, design images, and measurement inputs, utilizing the platform's customization tools.
3. Designer/Vendor Selection: Users browse through a diverse selection of designers/vendors, exploring their portfolios and specialties before making a selection.
4. Collaboration: Direct communication channels facilitate seamless collaboration between users and designers/vendors throughout the design process, ensuring clarity and alignment of vision.
5. Secure Transactions: Users complete transactions securely through the platform's payment gateway, with multiple payment options available to suit individual preferences.
6. Order Tracking and Feedback: Users can track the progress of their orders in real-time and provide feedback and ratings upon receiving their custom-made clothing, contributing to a transparent and trustworthy community ecosystem.

The platform operates on a business-to-consumer (B2C) basis, directly engaging with users and vendors within the fashion industry. The business model revolves around charging subscription fees, transaction fees, and other fees for add-on services to both customers and designers/vendors. These fees ensure sustainable revenue generation while providing users and vendors with access to a wide range of features and services aimed at enhancing their custom clothing experience. Leveraging this B2C model fosters a thriving ecosystem where individuals can seamlessly connect, collaborate, and create bespoke fashion pieces tailored to their unique preferences and styles.

### 1. Introduction

### 1.1. Purpose

This System Design Specification outlines the architecture and features of the platform according the present invention-a mobile and web application designed for fabric sellers, tailors, designers, and customers (fashion enthusiasts).

### 1.2. System Overview

This mobile/web application serves as a platform for designers and tailors to showcase their work and allows customers to book for consultations, take fittings, place orders and have them delivered wherein the platform offers a fabric marketplace where sellers can list their products.

### 2. Design Considerations

User Behavior: Users are familiar with basic navigation and interaction in web and mobile applications.

Data Availability: Data from external sources is accurate and up to date.

Internet Connectivity: End-users have a reliable internet connection with reasonable bandwidth. Security Compliance: The organization's security policies and compliance measures are followed during system development.

Budget Allocation: The allocated budget for system design and development is sufficient to meet project requirements.

Third-Party Service Availability: Third-party services and APIs used in the system remain available and continue to support the application.

The backend of the system and the database may be hosted on AWS.

The file storage may be on AWS S3.

### 2.4 Design Methodology

The application utilizes the Model View Controller (MVC) design pattern. The primary purpose of the MVC pattern is to separate an application's concerns into three interconnected components, each responsible for different aspects of the application's functionality. This separation promotes modularity, maintainability, and the ability to make changes to one component without affecting the others.

### 3. System Architecture

The system includes a client-server architecture, with the following key components:

### 3.1. Client Side

### 3.1.1. Mobile Application (React Native)

The mobile application is for Android and iOS platforms.

The mobile application allows fabric sellers, designers, tailors, and customers to access the platform on their mobile devices.

The mobile application utilizes responsive design principles for a user-friendly experience.

### 3.1.2. Web Application (React JS)

Provides an alternative access point for users on desktop or web browsers.

Ensures compatibility across major web browsers.

### 3.2. Server Side

### 3.2.1. API (PHP: Laravel Framework)

Manages user authentication and authorization.

Handles business logic, including product listings, portfolio management, order processing, payments and appointment scheduling.

Provides RESTful APIs for client-side interactions.

### 3.2.2. Database (MySQL/Microsoft SQL Server-for Enterprise Level)

Stores user data, product listings, portfolio information, booking details, and messaging data.
Utilizes a relational database management system for structured data storage.

### 3.2.3. Cloud Storage (Amazon S3 or Google Cloud Storage)

Stores product images and media files.
Utilizes cloud-based storage solutions

### 4. Key Features

### 4.1. User Management

User registration and authentication.

Role-based access control for sellers, designers, tailors, and customers.

### 4.2. Fabric Marketplace

Sellers can add, edit, and manage fabric product listings.

Customers can search for and view product details, add items to a cart, and make purchases. Integration with payment gateways for secure transactions.

### 4.3. Portfolio Management

Designers and tailors can create, edit, and manage their portfolios.

Showcase previous work, services offered, and availability for bookings.

### 4.4. Booking and Messaging

Customers can book appointments for consultations and fittings with designers and tailors.
In-app messaging to facilitate communication between customers and service providers.
Notification system to alert users about new bookings and messages.

### 5. User Interfaces

The app consists of three primary user interfaces:

### Seller Interface

Fabric sellers can use this interface to:
Register and create an account.
Add, edit, and manage fabric products for sale.
Set prices, upload images, and provide product descriptions.

### Designer/Tailor Interface

Designers and tailors can use this interface to:
Register and create an account.
Create and manage their portfolio, showcasing their work, services, and availability.
Receive booking requests from customers.
Communicate with customers and schedule consultations and fittings.

### Customer Interface

Customers can use this interface to:
Register and create an account.
Browse and search for fabric products from sellers.
Buy products and track their orders.
Explore designer and tailor portfolios.
Book appointments for consultations and fittings.
Communicate with designers, tailors, and sellers.

Databases may include a Staging Environment and a Production Environment.

### 6.2. Tables

Users
PortfolioItems
Products
WishlistItems
Reviews
Orders
OrderItems
Invoices
Sales
BlockedDates
Bookings
Dates
Payments

### 6.3. Table Relationships

Users <-> PortfolioItems

Relationship: One-to-Many

Users <-> Products

Relationship: One-to-Many

Users <-> WishlistItems

Relationship: One-to-Many

Users <-> Orders

Relationship: One-to-Many

Users <-> Reviews

Relationship: One-to-Many

Users <-> Bookings

Relationship: One-to-Many

Users <-> BlockedDates

Relationship: One-to-Many

Bookings <-> Dates

Relationship: One-to-Many

Orders <-> OrderItems

Relationship: One-to-Many

Orders <-> Invoices

Relationship: One-to-One

Orders <-> Sales

Relationship: One-to-One

Invoices <-> Payments

Relationship: One-to-Many

Sales <-> Payments

Relationship: One-to-Many

Products <-> OrderItems

Relationship: Many-to-Many

Products <-> WishlistItems

Relationship: Many-to-Many

Products <-> Reviews

Relationship: One-to-Many

### 7. Security Considerations

Use of HTTPS for secure data transmission.

Secure storage of user data and sensitive information.

Regular security audits and updates to protect against vulnerabilities.

### 8. Scalability

The system is designed to handle potential growth, both in terms of users and data. This includes database scaling and efficient use of resources.

### 9. Data Privacy and Compliance

The system complies with relevant data privacy laws and have mechanisms for users to control their data.

### 10. Performance and Testing

Performance testing should be conducted to ensure the application performs well under various loads. Regular testing, including unit tests, integration tests, and user acceptance tests, should be conducted to maintain quality.

### 11. Deployment

The system is deployed on a cloud infrastructure (AWS) for scalability and ease of maintenance.

### 12. Maintenance and Support

A plan for ongoing maintenance, bug fixes, updates, and customer support should be in place to ensure a reliable user experience.

The system design specification provides an overview of the mobile and web application for fabric sellers, designers, tailors, and customers. The platform includes bookings, enhancing the experience for all users involved in the fashion industry. The use of React Native and React JS, along with the PHP (Laravel Framework) and MySQL backend, ensures a modern, efficient, and scalable solution.

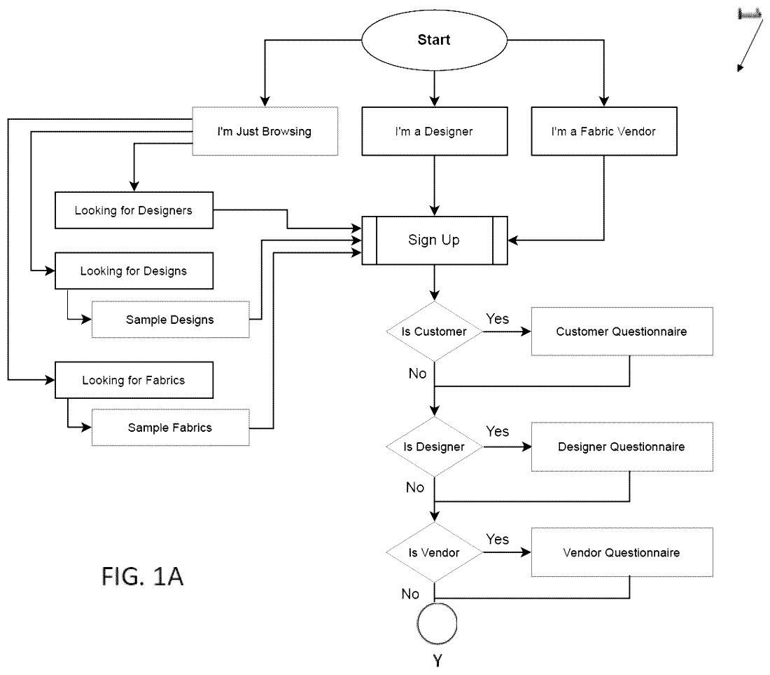

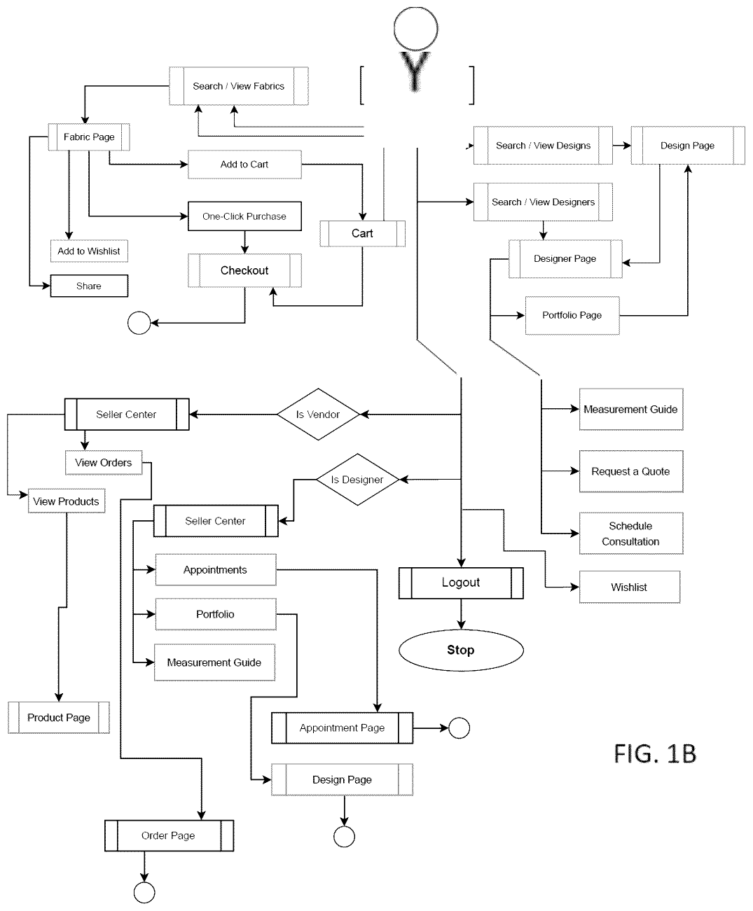

FIGS. 1A and 1B show a flowchart of the platform according to the present invention.

The specific goals of the fashion app are to help bring couture and ready-to-wear fashion, fashion designers, and fabric sellers to one place to serve a wide range of customers.

The Fashion app will be versatile in creating a market for Fabric sellers and textile manufacturers to display their products, tailors to showcase catalogs of sewn clothes, and designers can sell, and collaborate with tailors and fabric sellers

The target users of the fashion app are:
1. African Print Fabric Sellers: Including both local artisans and international vendors, contributing to a vibrant marketplace.
2. Multi-Fabric Sellers: Embracing diversity, catering to the preferences of users from various backgrounds and regions.
3. International and Local Fashion Designers: Offering a platform for skillful tailors to showcase their work to a global audience.
4. Clients: Encompassing both local and international consumers seeking unique, culturally rich fashion.
5. Fashion Designers: Welcoming local and international talents, fostering collaboration with tailors and fabric sellers. In the US, Canada, Nigeria, and Ghana, building a strong foundation for phase 1, with expansion plans in phase 2 for other regions.
6. Custom/Couture Fashion Lovers: Primarily targeting the diaspora, with a significant focus on the US, Canada, Europe, and Africa.
7. Genders and Ages: Catering to a broad range of genders and ages, ensuring accessibility for both the young generation under guardianship and adult users.

Some features of the fashion app are:
1. User Registration and Profiles: Seamless account creation with essential details.
2. Verification and Validation: Ensures user authenticity and security.
3. Fashion Designer Profiles: Access to detailed profiles of skilled professionals (They must have an active social media page). Showcasing designer portfolios and creations.
4. Fabric Catalog: Extensive collection of fabrics for custom choices.
5. Measurement Guide: Easy guidance for accurate measurements. (Photo Upload, Live Capture (Video sample on how to take the measurement))
6. Tailor Availability: Real-time availability status of tailors. (Calendar)
7. Booking and Appointments: Schedule appointments for fittings and consultations. (Post delivery)
8. Order Placement: Intuitive order creation process.
9. Shipping Partners: Partnerships for reliable and efficient shipping.
10. Payment Gateway: Secure transactions for buying and selling.
11. Customization Options: Personalize fabric prints for unique designs.
12. Chatbots: Instant communication for quick queries.
13. Order Tracking: Real-time tracking of order progress.
14. Portfolio Showcases: Showcasing tailor and designer portfolios.
15. Product Browsing and Filtering: Easy navigation through products.
16. Detailed Product Views: In-depth views for informed choices.
17. Shopping Cart and Checkout: Seamless purchase process.
18. Order Tracking and Notifications: Updates on order status.
19. User Reviews and Ratings: Insights from others' experiences.
20. Search Functionality: Quick product search.
21. Push Notifications: Alerts on new arrivals and promotions.
22. Social Sharing and Engagement: Sharing options for social platforms.
23. Size Recommendations: AI-driven size suggestions.
24. Virtual Fitting Room: Trying on clothes virtually.
25. Style AI Recommendations: Personalized style recommendations.
26. Sustainability Insights: Information on eco-friendly materials.
27. 3D Product Views: Enhanced product visualization.
28. Exclusive Designer Collections: Special collections from designers.
29. Try-Before-Buy Subscription: Subscription-based try-before-buy option.→For future add-on
30. Augmented Reality Fashion Shows: Immersive virtual fashion events.
31. Fashion AI Trends: AI-driven trend forecasts.
32. Custom Fabric Printing: Printing own designs on fabrics.
33. Live Designer Q&A Sessions: Direct interaction with designers.
34. Visual Wardrobe Organizer: Organizing purchased items.
35. Eco-Friendly Material Filters: Sorting by sustainable materials.
36. User Wishlist and Favorites: Saving preferred items.
37. One-Click Purchases: Streamlined purchasing process.
38. Live Streaming Fashion Shows: Real-time fashion showcases.
39. Augmented Reality Accessories: Try-on virtual accessories.
40. User Feedback Integration: In-app feedback submission.
41. Size Inclusivity: Catering to diverse body types.
42. Quick Reorder: Rapid reorder of favorite items.
43. Video Product Demonstrations: Visual demos of products.
44. Localized Content: Tailored content for different regions.
45. User-Generated Challenges: Engaging challenges for users.
46. In-app Wardrobe Styling: Styling outfits within the app.
47. Personal Stylist Consultation: Expert style advice.

Key Features for Fashion Designer Vendors:
1. User-friendly Profile Creation: Easy setup of professional profiles.
2. Detailed Vendor Information: Showcasing expertise, portfolio, and references.
3. Direct Communication: Message and video boards for client interaction.
4. Fabric Display: Display fabrics for sale.
5. Availability Calendar: Displaying availability for bookings.
6. Star Rating System: User-driven ratings for vendor credibility.
7. Shipping Profile Management: Control over the shipping process.
8. Comments: Access to their social media accounts
9. Fashion Trends Insights: Access to AI-driven trend forecasts.
10. No screen capture.

Key Features for Fabric Vendors:
1. Vendor Profile Creation: Setting up vendor profiles.
2. Fabric Collection: Showcasing fabric offerings.
3. Shipping Profile Management: Independent management of shipping.
4. Integration with Designers: Option for designers to use vendor fabrics.

The specific requirements for each task are:
User interface (UI) design: The UI design should be user-friendly and easy to navigate. It should also be visually appealing and engaging.
User experience (UX) design: The UX design should focus on the user's needs and how they will interact with the app. It should be clear and concise, and it should help users to achieve their goals quickly and easily.
Information architecture (IA): The IA should define the structure of the app's content. It should ensure that the content is organized in a way that is easy for users to find and understand.
Visual design: The visual design should use colors, fonts, and other elements to create a cohesive and visually appealing look and feel for the app.
Accessibility: The app should be accessible to users with disabilities. This includes features such as text-to-speech and high-contrast mode.

Task: User Registration and Authentication
Requirements:
   Users can register using email or social media accounts.
   Registration form includes fields for name, email, password, and profile picture.
   Passwords must meet security criteria (e.g., minimum length, special characters).
   User data (excluding passwords) is stored securely in the database.
   Users can log in with registered credentials.
   Forgot password functionality allows users to reset their passwords via email.

### Task: Product Browsing and Filtering

Requirements:
   App displays a categorized product list on the home page.
   Users can click on categories to view specific product listings.
   Filtering options include price range, size, color, and category.
   Filtered results update dynamically without requiring page reloads.
   Users can sort products by relevance, price, and popularity.

### 2. Task: Product Details and Imagery

Requirements:
   Each product listing includes a product name, price, description, and images.
   Users can view high-resolution images by clicking on product thumbnails.
   Zoom functionality allows users to see product details.

### Task: Shopping Cart and Checkout

Requirements:
   Users can add products to the shopping cart.
   Cart icon displays the number of items added.
   Cart page lists selected items, quantities, and total cost.
Users can adjust quantities or remove items from the cart.
Secure checkout process with payment options (e.g., credit card, PayPal).
User receives an order confirmation email.

### Task: User Profiles and Order History

Requirements:
   Each user has a profile page displaying personal information.
   The profile page also shows order history and current order status.
   Users can click on orders to view detailed order information.
   Users can initiate returns for products in a specified timeframe.

### Task: Search Functionality

Requirements:
   App includes a search bar for users to search for products.
   Search results display matching products in real time.
   Results can be filtered and sorted similarly to regular product listings.

### Task: Push Notifications

Requirements:
   App sends push notifications for order confirmations, promotions, and price alerts.
   Users can opt-in/out of notifications in their profile settings.
   Notifications are platform-specific (e.g., iOS, Android).

### Task: Social Sharing and Reviews

Requirements:
   Users can share products on social media platforms.
   Product listings display average ratings and reviews.
   Users can leave reviews and star ratings for products they've purchased.

### The Dependencies Between Tasks are

1. User Registration and Profile Setup:
   Dependency: Users must register and set up profiles before they can upload measurements and photos.
2. User Uploading Measurements and Full Body Photos (Users):
   Dependency: Users need to upload accurate measurements and full body photos before customization can be accurately performed.
3. Size Conversion Options (Developers):
   Dependency: Developers need to integrate size conversion options (UK, US, CHN) after receiving user measurements. (Metric Systems (inches, cm, m|Lbs. vs Kgs))
4. Designing Customization UI (Designers):
   Dependency: Designers need to finalize the customization interface after size options are integrated.
5. Integrating Fashion Designer Profiles (Developers):
   Dependency: Tailor and designer profiles can be integrated once profiles are set up and customization is finalized.
6. User Customization (Users):
   Dependency: Users can customize products only after measurements are uploaded and size options are integrated.
7. Fabric Services Integration (Developers):
   Dependency: Developers need accurate customization data before integrating fabric availability from fabric services.
8. Tailoring Orders and Scheduling (Tailors):
   Dependency: Tailors need precise customization data to fulfill orders accurately.
9. User Reviews and Feedback (Users):
   Dependency: Users can leave reviews and feedback after experiencing the customization process and receiving orders.
10. Quality Check and Testing (QA Team):
   Dependency: Tailoring orders need to be accurately processed for quality check, considering customization accuracy.
11. App Maintenance and Updates (Developers):
   Dependency: Ongoing coordination with tailors, designers, and fabric services for updates and maintenance.
12. User Education on Customization (Marketing & Developers):
   Dependency: Marketing needs accurate customization details to effectively promote this feature.
13. Fabric Services and Inventory Updates (Fabric Services):
   Dependency: Fabric services need to update inventory based on customization trends and orders.

### WORKFLOW

Initiation Stage:

Clients:
1. Define Goals and Scope (Day 1-Day 3)
   Clients outline project goals and scope, emphasizing the app's couture and ready-to-wear fashion, Contemporary fashion, tailor, fabric seller, and designer integration.
   Metrics: Clearly defined project goals and scope.
   Register company: The clients should register their company with the relevant authorities.
   Pick a color theme: The clients should pick a color theme for the fashion app. This will help developers to create a consistent and cohesive look and feel for the app.
   Logo sketch: The clients should create a logo sketch for the fashion app. This will help developers to define the visual identity of the app.

Developers:
1. Project Kickoff (Day 1)
   The project manager conducts a kickoff meeting to introduce the team, establish expectations, and align everyone with project objectives.
   Metrics: Successful project kickoff and team alignment.

Requirements Gathering Stage:

Clients: 2. Provide User Personas and Stories (Day 4-Day 7)
Clients submit detailed user personas and stories to set the foundation for functional requirements.
Metrics: Completed user personas and stories documentation.
   Developers: 2. Analyze User Personas and Stories (Day 8-Day 10)
The development team thoroughly examines user personas and stories to extract functional requirements.
Metrics: Comprehensive analysis of user personas and stories.

Design Stage:

Clients: 3. Review and Approve Wireframes (Day 11-Day 14)
Clients evaluate and endorse wireframes and prototypes that illustrate the app's layout and structure.
Metrics: Approved wireframes and prototypes.

Developers: 3. Develop User Interface (UI) (Day 15-Day 20)
UI designers craft the app's user interface according to the approved wireframes.
Metrics: Completed UI design phase.

Development Stage:

Clients: 4. Provide Fabric Catalog Data (Day 21-Day 25)
Clients supply data for the fabric catalog, contributing to the app's material diversity.
Metrics: Fabric catalog data integration.

Developers: 4. Integrate Fabric Catalog (Day 26-Day 30)
Developers seamlessly integrate the fabric catalog feature, enabling users to explore available textiles.
Metrics: Successful fabric catalog integration.

Deployment Stage:

Clients: 5. Provide Designer Profiles and Catalogs (Day 31-Day 35)
Clients furnish data for designer profiles and catalogs, enhancing the app's designer-centric functionality.
Metrics: Designer profiles and catalog data integration.

Developers: 5. Integrate Designer Profiles and Catalogs (Day 36-Day 40)
Developers merge designer profiles and catalogs into the app, fostering connections between users and designers.
Metrics: Successful designer profiles and catalog integration.

Maintenance and Support Stage:

Clients: 6. User Testing and Feedback (Day 41-Day 45)
Clients conduct user testing and gather feedback, ensuring user-centric design and functionality.
Metrics: Comprehensive user feedback collection.

Developers: 6. Refinement and Bug Fixing (Day 46-Day 50)
The development team refines the app based on user feedback, addressing bugs and enhancing user experience.
Metrics: User feedback addressed, enhanced app functionality.

Quality Check and Assurance Stage:

Clients: 7. Review Final App Version (Day 51-Day 55)
Clients review the final app version, verifying alignment with project goals and requirements.
Metrics: Final app version approval.

Developers: 7. Quality Assurance Testing (Day 56-Day 60)
The QA team conducts rigorous testing to ensure the app's performance, usability, and absence of errors.
Metrics: Successful QA testing, and error resolution.

Launch Stage:

Clients: 8. Launch Preparation (Day 61-Day 65)
Clients prepare for the app's launch, devising marketing strategies and ensuring optimal user experiences.
Metrics: Launch plan readiness.

Developers: 8. App Deployment and Launch (Day 66-Day 70)
Developers deploy app-to-app stores, making it available to users for download and usage.
Metrics: Successful app deployment and launch.

Post-Launch Stage:

Clients: 9. Monitor User Engagement (Ongoing)
Clients analyze user engagement metrics, assess user feedback, and ensure ongoing user satisfaction.
Metrics: Tracked user engagement metrics, user feedback integration.

Developers: 9. Continuous Monitoring and Updates (Ongoing)
The development team consistently monitors app performance, attends to user issues, and introduces updates.
Metrics: App performance vigilance, updates implementation.

The present invention is directed to an app for IOS and Android, and a website for providing a platform for connecting fashion lovers with talented fashion designers that can deliver exactly what the client wants. Many people in the diaspora struggle with access to good and exceptional fashion designers who are readily available to make and deliver quality custom-made clothing.

With the platform, people living in the US and Canada, though not only limited to these locations, can have access to these designers located in the US, Canada, Nigeria, Ghana, as well as other feasible locations. The choice is up to the customer to decide which fashion designer to work with and these designers is pre-selected and signed up on the platform.

The platform is a designer/vendor platform as well as User/Customer platform. Vendors go through a pre-qualification process to ensure they meet the vision, core values and standards, which includes—professionalism, integrity, speed, reliability, excellence, superior quality, positive customer experience, to name a few. A profile is created for each designer and whenever a customer's request comes in, they are able to respond to the customer requests until the order is closed.

The platform includes an option for designers to display fabrics on sale, which the customer can decide to purchase. These fabrics are sold per yard, and are either be sold by the respective vendors or the holding company of the app.

The types of clothing to be designed and sewn include custom/couture fashion for men, women and children, as well as contemporary Western clothing, dinner gowns, etc.

The target market includes:
1. Male and female custom/couture fashion lovers in the diaspora with more focus on the US and Canadian market, but open to Europe and Africa as well.
2. All ages—young (Minor—Guardian triggered) and adults. Users must be above 18 yrs. to sign up for the app.
3. Fashion designers as vendors in US, Canada, Nigeria and Ghana for phase 1 and others outside of these geo-physical locations for phase 2.

### Key Features for Customer

The customer provides a username and password in order to create an account.
The customer's basic profile includes full names, mailing address, email, and a profile picture.
At time of intent to purchase, the customer submits a short description of the desired clothing, pictures of the clothing design (to include, front, back and side views), body measurements, and preferred turn-around time.
The app includes a minimum list for body measurements for the customer to provide and includes AI technology integrated in the app to transcribe body measurements from recently uploaded pictures of the customers or body scan via camera.
The app includes a message and video board for direct contact with respective designers as well as a payment platform

### Key Features for Designer Vendor

The vendor provides a username and password to create a profile.
The vendor basic profile includes full names, location, a short description of the vendor company and capabilities, work portfolio (including pictures), references, and a video introducing themselves and their work.
A message and video board—audio and video capabilities, maybe zoom-integrated.
An option for designers to display their fabrics for sale to potential customers.
An active calendar that shows designers' availability.
A star rating portion which customer has access to post-delivery of their clothing. If the vendor rating goes below 3.5, a warning is given, and when below 3.0, vendor is automatically removed from the platform.
The ability to create a shipping profile which they manage independently. Incentives is given to designers who manage shipping of their products.

### Key features for Fabric Vendors (Similar to Esty or the Like)

The vendor creates a profile.
The vendor has a collection of fabrics available to be sold per yard or in bundles.
The ability to create a shipping profile which the vendor manages independently. Incentives is given to vendors who manage shipping of their products.

Customers also have the option of shipping their fabrics to their selected designers. However, in the absence of this, there is an option of fabrics sold by the fashion designer/vendors.

### App Security and Verification

1. A solid Tech backbone is deployed with high security to ward-off scammers and hackers.
2. A secure server with adequate capacity to accommodate contents and app processes is deployed.
3. This is a paid service. Any member that wants to join has to pay the associated fee. There is no free trial at any point in time because of regions of operation.
4. The platform may include a ‘free or trial package’ with limited features at the initial stage of the app.
5. Any suspected fraudulent activity is flagged, reported and blocked, same applies for suspicious profiles. The tech deployed should be able to intelligently detect this.
6. A ‘report’ button for members is needed so they can flag or report suspicious accounts that tech team may miss but it should be advised that this button be used sparingly and not in retaliation or annoyance.
7. There is no exchange of contact details such as phone numbers or emails until a certain milestone is reached and also depending on the package selected. Phone numbers and emails is encrypted if a member includes this in any contact. All communication is done through the app. A toll-free number is available for customer support.
8. A chat box feature is available should customers have initial questions prior to committing to signing up/creating a profile.
9. A “contact us” button is available for registered members.
10. Terms of use, FAQ, privacy, success tips, success stories are visibly displayed.
11. An NDA/Non-circumvent agreement shall be in place in the app between customers, vendors (designers and fabric suppliers).
12. A good UI and UX is paramount. The UI is extremely important and should portray just enough of what is required. UX should be so exciting and plays a major role in user retention especially for first time visitors just to satisfy curiosity.
13. Designers must have an active social media page, be tech savvy, and own a smart device.
14. Customer can contact ALL designers (job board e.g. like Upwork) or can select specific designers. Vendors need to respond within 24 hours, otherwise, their rating drops if customers message specific designers.
15. An OTP verification (email or text message) would be validated upon account sign-up for all users.

### Business Model and Strategy

Company identifies fashion designers (who have their own tailors/seamstresses) in North America, UK, Nigeria and Ghana for phase 1. The company needs to have a document detailing information about the fashion app and expectations to provide to these designers to help them make an informed decision.
An animated video showing interested customers/vendors what to expect from creating a profile to product delivery.
Pricing: The designers determine the sales price of their product and the company applies a percentage commission (15-20%).
Shipping: The designer and/or company is responsible. An A-Star rating is added to the profiles of designers that take on shipping responsibilities (i.e. A-rate designers).
Client Search: social media, paid campaigns and influencers, giveaways, billboard adverts, brand ambassadors (local and international), PR Companies.
The company determines turn-around time (14 calendar days, excluding shipping), with the option of expedited services (7 calendar days, excluding shipping), once fabric, design and measurements are provided/available.
A 60% down payment is required by the customer once terms of engagement is signed. The outstanding balance is paid prior to shipping.
The designers need to be open to making amendments post-shipping irrespective of which designer produced the initial product.

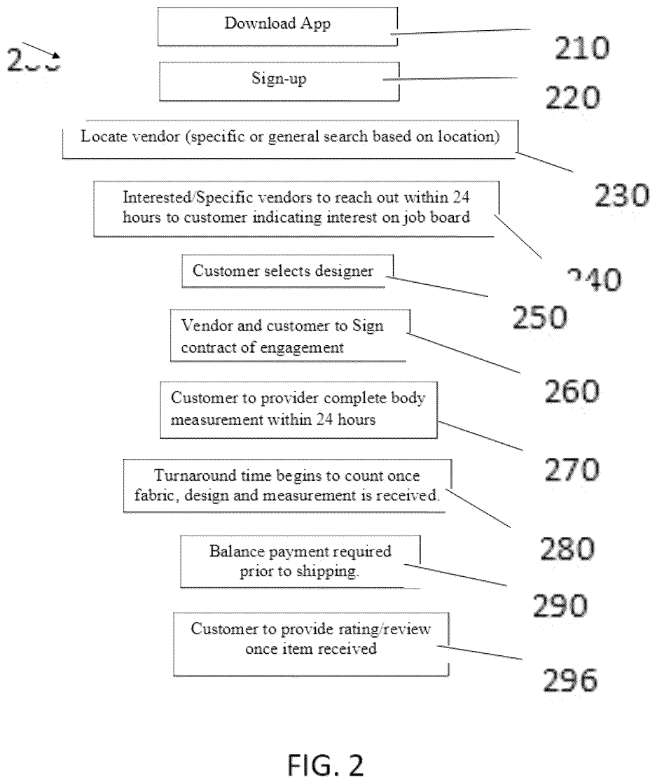

FIG. 2 shows a flowchart 200 of an example of a customer in a specific location sourcing customized clothing. The designers need to be open to making amendments post-shipping irrespective of which designer produced the initial product.

The steps include downloading the app 210, and signing up as a customer 220. The steps include locating a vendor 230 (specific or general search based on location) and interested/specific vendors to reach out within 24 hours to customer indicating interest on job board communication 240. The steps include the customer selecting a designer 250, the vendor and customer signing the contract of engagement 260, and the customer to provide complete body measurement within 24 hours 270. The steps include the turnaround time beginning to count once the fabric, design and measurement is received 280 and the balance payment made prior to shipping 290. The steps may include the customer providing rating/review once item received 296.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A platform for connecting couture and ready-to-wear fashion inclined clients with fashion designers through fashion designer vendors wherein the fashion designer vendors provide couture and ready-to-wear fashion products for the client, the couture and ready-to-wear fashion products including quality custom-made clothing, the platform comprising:
a space for fashion designer vendors to display fabrics on sale;
a message board for the fashion designer vendors; and
a message board for the client;
wherein the fashion designer vendors create a profile on the platform, including a shipping profile;
wherein the client selects at least one designer as a preferred designer to allow the platform to provide a preferred couture and ready-to-wear fashion selection from the platform; and
wherein the platform includes steps to coordinate selection, purchase and delivery of couture and ready-to-wear fashion products from the fashion designer vendors to the client.
